(19) United States
(12) Patent Application Publication
(10) Pub. No.: US 2020/0399933 A1
(43) Pub. Date: Dec. 24, 2020

(54) PEDESTAL WRAP SECURITY DEVICE

(71) Applicants: Christopher A. Kelsch, Palm Harbor, FL (US); Vanguard Products Group, Inc., Oldsmar, FL (US)

(72) Inventors: Christopher A. Kelsch, Palm Harbor, FL (US); Jasen P. Biggins, Palm Harbor, FL (US); Lee H. Eckert, Sarasota, FL (US); Robert E. Ekle, JR., Land O Lakes, FL (US); Joel A. Jenkins, Wesley Chapel, FL (US)

(73) Assignee: Vanguard Products Group, Inc., Oldsmar, FL (US)

(21) Appl. No.: 16/902,695

(22) Filed: Jun. 16, 2020

Related U.S. Application Data
(60) Provisional application No. 62/864,756, filed on Jun. 21, 2019.
(60) Provisional application No. 62/865,543, filed on Jun. 24, 2019.

(51) Int. Cl. E05B 73/00; E05B 35/00

(52) U.S. Cl. CPC E05B 73/0011; E05B 47/0045; E05B 35/008

(57) ABSTRACT

A security device for a retail item or packaging has housing that retains a gear that is operably connected to a pawl with two arms. One arm of the pawl is operably engaged by the gear. The other arm of the pawl is operably engaged with an unlocking key within the housing. The unlocking key is operably controlled by an unlocking tool by inserting a portion of the unlocking tool into a complementary portion of the unlocking key through a keyway formed in the housing. The unlocking key may have a magnet or components that are attracted to a magnet that enable the unlocking key to disengage a slot formed in the housing to allow the unlocking key to rotate to move the pawl. The housing may additionally be formed with a channel that allows a plurality of similarly constructed security devices to be tethered or daisy-chained together.

### CROSS REFERENCE TO RELATED APPLICATIONS

The present disclosure claims priority to U.S. Provisional Patent Application Ser. No. 62/865,543, filed on Jun. 24, 2019, and priority to U.S. Provisional Patent Application Ser. No. 62/864,756, filed on Jun. 21, 2019; the entirety of each is incorporated by reference as if fully re-written herein.

### TECHNICAL FIELD

The present disclosure relates generally to a security device. More particularly, the present relates to an adjustable security device which wraps around and secures a box, book, or other similarly structured retail items or articles of various sizes in a closed position. Specifically, the present disclosure relates to a universal security device which includes a plurality of wires or cables that wrap around the article and extend between a ratchet member and a locking member, both of which require a special tool to operate, and an unlocking mechanism associated with a unique key. Additionally, the present disclosure provides that the security device may be tethered to additional security devices or to a fixed anchor.

### BACKGROUND

Retail stores sometimes have a difficult time protecting or retaining items/boxes containing various expensive merchandise, books and other similarly structured packages or objects from being opened and the contents thereof being removed without authorization from store personnel or damaged while on display. Consumers often want to visually inspect the packaged expensive articles before deciding to purchase them. The store is faced with the problem of how to protect these expensive articles from theft while displaying them for sale.

One method used to protect these packages and the articles contained therein is to enclose the article within a transparent glass display case which sometimes can only be accessed from behind a counter of the retail store. The consumer can view the article through the glass but is not able to handle the article or read any of the information about the article that may be printed on the box unless a store clerk removes the article from the case. However, in large retail stores, the problem then arises of getting the selected merchandise to the customer after the customer wishes to purchase the same without subjecting the merchandise to theft. One manner is to maintain a supply of the boxes containing the expensive articles or merchandise close at hand for delivery to or pick-up by the customer for subsequent taking to a check-out clerk. However this makes the boxes susceptible to theft.

Another method used by retail stores is to list the article in a catalog and require consumers to place an order from the catalog. The article is delivered from a back storage area and the consumer must simultaneously pick up and pay for the merchandise at the same location to prevent unauthorized removal from the store. The consumer does not get to inspect the article before purchasing and if they are not satisfied they must undergo the hassle of returning the article for a refund.

Boxes and box-like structures are also subjected to unauthorized openings while being shipped via a courier. These articles can be easily opened and resealed when packaged and taped-shut in the conventional manner without the recipient or the sender knowing of such actions. Shipped packages can be secured within a security container with a locking mechanism but these containers are expensive to purchase and add size and weight to the package making it more expensive to ship. Also, would-be thieves can gain unauthorized access to the contents of these containers by “picking” the locking mechanisms or possibly guessing the combination to a combination lock.

Few prior art locking devices have adequately solved this problem of securing packages or objects in a closed condition while being displayed in retail stores or shipped from one location to another. Some prior art security devices include a wire which wraps around an article and is secured by some type of locking mechanism.

### SUMMARY

Issues continue to exist with security devices that wrap around and secure the retail package. The present disclosure addresses these and other issues by providing a security device having a cable that wraps around the retail package with an improved locking and cable ratcheting mechanism but still allows the consumer to view a vast majority of the package or label or the retail item.

A problem that is solved by the pedestal wrap according to one aspect of the present disclosure is the enabling of the retail product/package artwork to be visible. In other security wrap solutions, a winder or puck must be placed on the front and rear of the package, or left and right of the package, blocking product photos and product descriptions and information. The pedestal wrap of the present disclosure can be placed underneath the product package, with the puck on top. Only the relatively thin cables are visible on the front, rear, left or right sides of the package. This minimizes blocking graphics and product descriptions. The four cable slots on the top of the pedestal allow the cable to vertically snug up against a box that is smaller in the X (width) and/or Y (depth) dimension than the pedestal itself.

Another problem solved by the present disclosure relates to the previous security devices having a lock axis that his coaxial with the primary axis (which may be central) thereof. This requires complex components to effectuate the locking action and rotation of a winding gear. The present disclosure addresses this need by separating or offsetting the lock axis relative to the primary axis of the security device. The present disclosure security device has a lock axis that may be eccentric to the primary or first axis of the security device that enables the locking key within the housing to be radially displaced from the main gear that is used to wind the cables. There may be a pawl that is rotatable about a pawl axis. In one embodiment, neither the primary axis, the lock axis, nor the pawl axis are coaxial with each other or any one of the other axes.

According to one aspect, an exemplary embodiment of the present disclosure may provide a security device for a retail item or packaging has a housing that retains a gear that is operably connected to a pawl with two arms. One arm of the pawl is operably engaged by the gear. The other arm of the pawl is operably engaged with an unlocking key within the housing. The unlocking key is operably controlled by an unlocking tool by inserting a portion of the unlocking tool into a complementary portion of the unlocking key through a keyway formed in the housing. The unlocking key may have a magnet or components that are attracted to a magnet that enable the unlocking key to disengage a slot formed in the housing to allow the unlocking key to rotate to move the pawl. The housing may additionally be formed with a channel that allows a plurality of similarly constructed security devices to be tethered or daisy-chained together.

In another aspect, an exemplary embodiment of the present disclosure may provide a security device comprising: a housing; a cable extending through the housing and adapted to extend around a package or item; a gear for winding the cable, wherein the gear is within the housing; and an unlocking key or mechanism operably connected to the gear within the housing, wherein the unlocking key or mechanism is moveable between locked and unlocked positions, wherein when in the locked position the elongated cable cannot unwind relative to the gear and when in the unlocked position the elongated cable freely unwinds. This exemplary embodiment or another exemplary embodiment may further provide a spring coupled to the unlocking key or mechanism providing a force along a lock axis that is parallel to a first axis of the housing, wherein the gear rotates relative to the first axis of the housing. This exemplary embodiment or another exemplary embodiment may further provide a first portion of a cylindrical sidewall on the unlocking key or mechanism oriented around the lock axis; and an arm extending radially outward from the first cylindrical sidewall relative to the lock axis. This exemplary embodiment or another exemplary embodiment may further provide a second portion of the cylindrical sidewall on the unlocking key or mechanism, wherein the first and second portion of the cylindrical sidewall extend coaxially along the lock axis. In one example, the first and second portion of the cylindrical sidewall have differing radiuses. Stated otherwise, there is an external diameter on each of the first portion of the cylindrical sidewall and the second portion of the cylindrical sidewall, wherein the external diameter is different for each of the first and second portions cylindrical sidewalls. In this embodiment, the arm that is connected to the second portion of the cylindrical sidewall can be below the first portion of the cylindrical sidewall.

This exemplary embodiment or another exemplary embodiment may further provide a lock axis; a bore defined by the unlocking key or mechanism; and a bar disposed within the bore, wherein the bar is configured to move along the lock axis relative to the bore. There may be a spring disposed within the bore. The lock axis may be offset from a first axis of the housing, and there can be a pawl defining a pawl axis offset parallel to the lock axis and to the first axis of the housing. As in other embodiments, the pawl may include first and second arms that define a space therebetween, wherein an arm on the unlocking key or mechanism disposed in the space between the first arm and the second arm of the pawl. There may also be a torsion spring connected to the second arm of the pawl.

This exemplary embodiment or another exemplary embodiment may further provide a first cable having first and second ends coupled to the gear; a second cable having first and second ends coupled to the gear; a puck connected to the first cable and the second cable intermediate the respective first and second ends of the first cable and the second cable. Still further, there may be a first portion of the puck defining a first channel receiving the first cable and a second channel defining the second cable; and a second portion of the puck that couples to the first portion to retain the first and second cables in the first and second channels, respectively.

This exemplary embodiment or another exemplary embodiment may further provide a pass through channel defined in the housing adapted to receive a tether therethrough that couples the security device to an anchor or another similar security device via the tether. The security device may also be provided with an unlocking tool adapted for use with the unlocking key to move the unlocking key between the unlocked and locked positions, wherein the unlocking tool has a portion complementary to the unlocking key. Further, the one unlocking tool can be used on each of security devices that are tethered together such that only a single tool is needed to unlock each device. However, differing tools specific to each security device are entirely possible.

In yet another aspect, an exemplary embodiment of the present disclosure may provide a method comprising: inserting an unlocking tool into a unlocking key that is exposed through a keyway aperture formed in a housing of a security device; moving the unlocking tool to move the unlocking key from a locked position to an unlocked position; engaging a first arm on a pawl with a portion of the unlocking key; disengaging a second arm on the pawl from a gear within the housing; unwinding cables that are spooled relative to the gear while rotating the gear; and increasing a length of the cables relative to an outside of the housing configured to enable a retail item to be removed from the security device. This exemplary method or another exemplary method may further provide rotating the pawl about a pawl axis in response to moving the unlocking tool to move the unlocking key from the locked position. This exemplary method or another exemplary method may further provide biasing the pawl from the unlocked positon towards the locked position with a torsion spring operably coupled to pawl and the housing. This exemplary method or another exemplary method may further provide wherein moving the unlocking tool is accomplished by rotating the unlocking tool about a lock axis that is offset parallel to the pawl axis and further comprising: magnetically attracting a portion of the unlocking tool to a portion of the unlocking key; This exemplary method or another exemplary method may further provide wherein the security device is a first security device from a plurality of similar security device, further comprising: connecting the first security device to a first object protected by the first security device; positioning a tether in a pass-through channel defined by a portion of a first security device; connecting the tether to one of: (i) an anchor; and (ii) a second security device via a pass-through channel defined by a portion of the second security device protecting a second object; and displaying the first object in a retail environment.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a perspective view of a security device in accordance with an exemplary embodiment of the present disclosure.

FIG. 2A is an exploded perspective view of components of the exemplary security device shown in FIG. 1.

FIG. 2B is an exploded perspective view of a puck of the exemplary security device shown in FIG. 1.

FIG. 3 is an exploded perspective view of a gear, cables, and a central hub.

FIG. 4 is an exploded perspective view of an unlocking key and its complementary components.

FIG. 5 is an assembled bottom view of the unlocking key and its components.

FIG. 6 is a plan view of the security device in accordance with one aspect of the present disclosure, shown with the cover removed.

FIG. 7 is a plan view of the security device in accordance with one aspect of the present disclosure, shown with the center hub removed.

FIG. 8A is a perspective view of a crank.

FIG. 8B is a perspective view of an unlocking tool.

FIG. 9 is a cross section view of the security device taken along line 9-9 in FIG. 1.

FIG. 10 is an enlarged plan view of the region labeled as “SEE FIG. 10” in FIG. 6.

FIG. 11 is a cross section view taken along line 11-11 in FIG. 10.

FIG. 12 is an operational cross section view of the unlocking key being moved to an unlocked position.

FIG. 13 is an enlarged operational view of the unlocking key and pawl.

FIG. 14 is a perspective view of a plurality security devices connected together via a cable.

FIG. 15 is an exploded view of an alternative embodiment of an unlocking key and pawl in the security device according to another aspect of the present disclosure.

FIG. 16 is an enlarged operational plan view of the unlocking key and pawl of FIG. 15.

FIG. 17A is an enlarged operational plan view of the unlocking key and pawl of FIG. 15 shown in a locked position.

FIG. 17B is an enlarged operational plan view of the unlocking key and pawl of FIG. 15 shown in an unlocked position.

Similar numbers refer to similar parts throughout the drawings.

### DETAILED DESCRIPTION

A security device, which may be commonly or colloquially referred to as a “Pedestal Wrap,” is shown throughout the figures generally at 10. Security device 10 includes a base or housing 12, a gear 14, a center hub 16, an unlocking key 18, a pawl 20, a puck 22, and at least one cable 24. The security device 10 is configured to attach to a retail packaging item or product to prevent or deter theft thereof or tampering therewith.

Housing 12 may be a substantially unibody or monolithic member that is integrally extruded, molded, printed, additively manufactured, removably machined, or formed as a unitary, monolithic member substantially fabricated from a rigid, manmade, material. In one example, metal or metal alloys, such as stainless steel or aluminum alloy, may form a substantial majority of the components or elements used to fabricate the housing 12 and the various components integrally formed, molded, or extruded therewith, or otherwise disposed therein. In another example, non-metal materials, such as rigid plastics or polymers, may form a substantial majority of the components or elements used to fabricate the housing 12 and the various components integrally formed, molded, or extruded therewith, or otherwise disposed therein. Housing 12 should withstand typical retail display handling from an customer holding the housing 12 while inspecting the retail package secured by device 10 without damaging the housing 12 or the retail packaging. While it is contemplated that the housing 12 and its additional components described herein are uniformly and integrally extruded, molded, or formed, it is entirely possible that the components of the tool body be formed separately from alternative materials as one having routine skill in the art would understand. In another example, the housing 12 may be formed from a generally rigid elastomeric material or rubber material configured to withstand deformation upon impact or bending by the customer or operator (i.e., a retail employee). Furthermore, while the components of the housing 12 are discussed below individually, it is to be clearly understood that some of the components and their corresponding reference elements of the housing 12 are portions, regions, or surfaces of the body and all form a respective element or component of the unitary housing 12. Thus, while the components may be discussed individually and identified relative to other elements or components of the housing 12, in this exemplary embodiment, there is a single tool body having the portions, regions, or surfaces described herein.

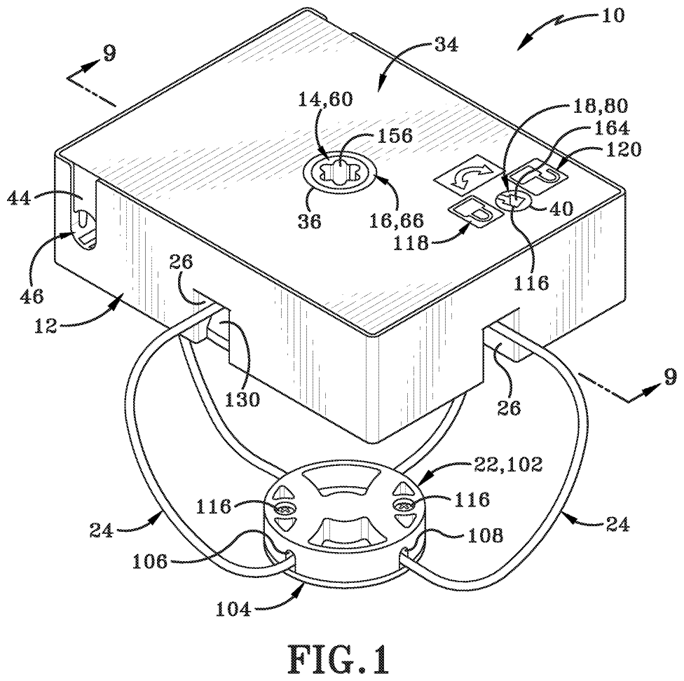

FIG. 1 depicts that housing 12 includes at least one sidewall defining a central space configured to receive the gear 14 and the central hub 16 therein. Housing 12 may include four sidewalls defining a generally rectangular box configuration, however other configurations are possible, such as a circular profile having only a single sidewall that defines a central space to receive the gear 14 and the central hub 16 therein. The at least one sidewall of housing 12 may define a plurality of openings 26 configured to receive portions of the cables 24 therethrough as will be described in greater detail herein. Openings 26 may have sidewalls that are flared outward or tapered inward (i.e., not parallel or not perpendicular) relative the a primary or first axis 38 of the security device 10. The openings 26 allow the cables 24 to be cinched onto a retail item having a smaller dimension than a width or length of the housing. In one particular implementation, housing 12 may include an open top and open bottom. A cover 28 may be secured to the housing 12 via screws 30 to cover one of the openings to the housing 12. In some implementations, cover 28 may be formed with slots or notches 32, which may cooperate and complementarily fit within similarly sized portions of housing 12. In other implementations, slots or apertures 32 formed in bottom cover 28 may receive portions of cable 24 extending therethrough.

Housing 12 may further include a cover 34 having a central aperture 36, which is centrally aligned with a primary or first axis 38 of the security device 10. Cover 34 may define a key opening 40, which is eccentric to the first axis of security device 10 and may be oriented offset from the central opening 36. The key opening 40 is positioned above the unlocking key 18 as is described in greater detail herein. Cover 34 is configured to cover the upper opening of housing 12 in order to secure the gear 14, the central hub 16, the unlocking key 18, and the pawl 20 within the interior portion or central space of housing 12. Cover 34 may have downwardly protruding or downwardly extending elements 42, which may retain or interact with portions of the central hub 16. Additionally, other downwardly protruding elements 44 extending from a lower major surface of the cover 34 may retain or interact with some of the apertures 26 or channel 46 formed in the sidewalls of housing 12 to define closed through openings through which portions of the cable 24 extend into and out of the central opening of housing 12 for connection with gear 14.

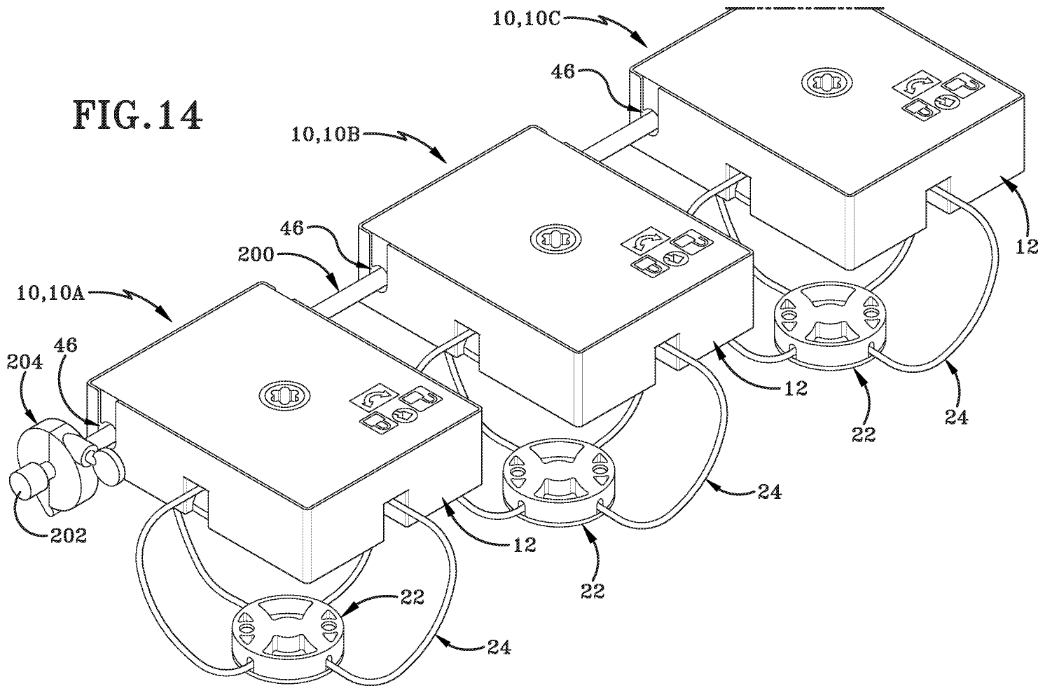

Housing 12 further defines the pass-through channel 46 that is fully enclosed by the downwardly extending element 44 on cover 34 when the cover 34 is connected with housing 12. The pass-through channel 46 extends fully from one side of the housing through the other to complete a through aperture extending fully through housing 12. Pass-through channel 46 may be arranged orthogonal to the first axis 38. In one particular embodiment, pass-through channel 46 is offset orthogonal to the first axis 38 of housing 12. Pass-through channel 46 may extend through the elongated sides of the housing 12 so as to define a shortened width relative to the length of the housing 12. However, other configurations are entirely possible, which would permit the pass-through channel 46 to extend through the shortened sides of the housing 12 so as to define an elongated length. Pass-through channel 46 is configured to receive a link or a tether (i.e., tether 200—FIG. 14) therethrough to secure the security device to another security device to create a daisy chain of a plurality of security devices, or alternatively, be connected with a tether that is rigidly and semi-permanently secured to a base station or other object, such as a display table. The pass-through channel 46 enables a plurality of security devices to be connected together so as to deter or make it difficult for someone to steal the box that is connected with the cables 24. The pass-through channel 46 may be connected with a tether so that someone viewing the box secured by the cables 24 does not inadvertently walk away from the display with the item protected by the security device 10. The plurality of devices connected together with a tether is shown in greater detail in FIG. 14.

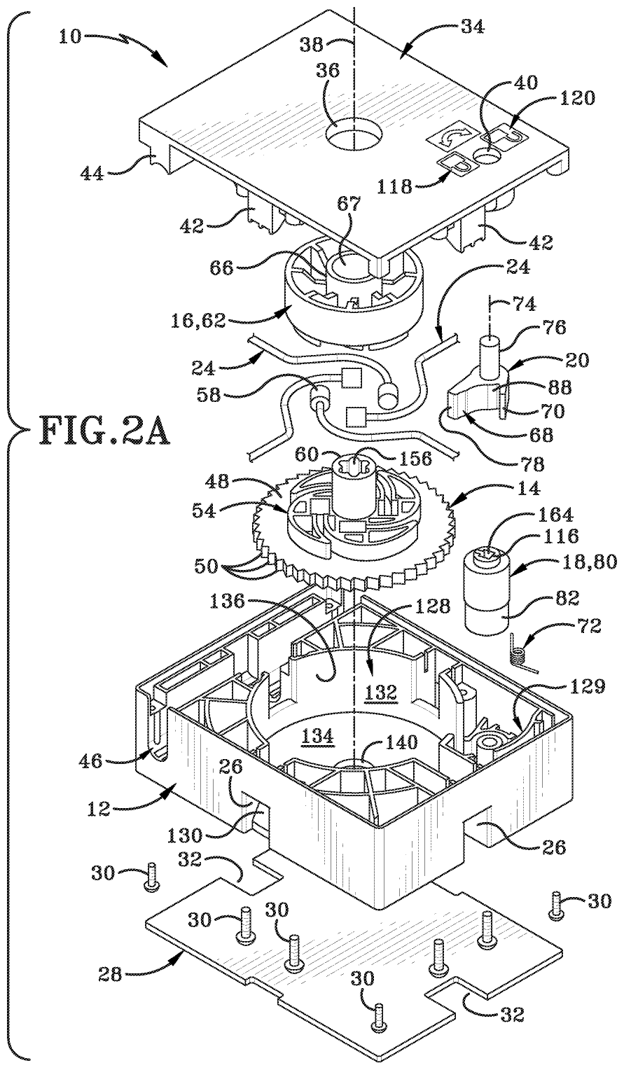

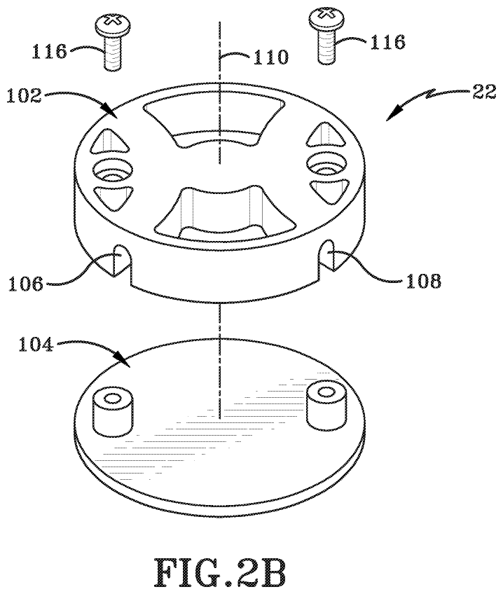

FIG. 2A and FIG. 3 gear 14 including a cylindrical disc-shaped member or disc 48, having a plurality of teeth 50 extending circumferentially there around at an outer edge. Disc 48 includes a first major surface 52. A retention member 54 extends upwardly from surface 52 defining a plurality of slots 56 configured to receive ends of cables 24 therein. The ends of cables 24 include barrels 58 that are larger than slots 56 such that the barrels 58 retain the cables securely to the retention member 54 in a recess or retention area 57 that is shaped complementary to barrels 58 while the cable 24 extends through the slots 56. A cylindrical member 60 extends upwardly from the retention member 54 and defines a central opening or bore aligned with the first axis 38. The central bore of cylinder 60 may define the shape of a six-pointed star having rounded corners. However, other unique configurations of the bore are entirely possible. In some instances, it is contemplated that the bore of cylinder 60 aligned with the central first axis 38 will not be circular in cross section inasmuch as the cylinder 60 is rigidly secured with a retention member 54 and the disc 48 and configured to rotate about the first axis 38 in order to wind the cables 24 to reduce their outwardly exposed diameter to secure the retail package or item, such as a box, to the security device 10. Thus, since the central bore of the barrel 58 is used to turn or wind the retention member 54, the shape of the bore of cylinder 60 should have corners and edges so as to increase friction during clockwise rotation of the gear 14 about the first axis 38.

FIG. 2B depicts puck 22 formed from a first part 102 and a second part 104. First part 102 defines first annular channel 106 and second annular channel 108. Annular channels 106, 108 extend curvlinearly through portions of the puck 22. The central second axis 110 may sometimes be coaxial with first axis 38, as shown in FIG. 1. However, the puck 22 may be adjusted to secure a box or content or other similarly shaped device that is to be protected by security device 10. In these instances, axis 110 would not necessarily be coaxial with axis 38. In some instances, the first part 102 of puck 22 has a generally circular profile. When viewed from above, first channel 106 extends curved linearly from approximately the 10 or 11 o'clock position to approximately the 7 or 8 o'clock position. Similarly, second channel 108 extends generally from about the 1 or 2 o'clock position to about the 4 or 5 o'clock position. The length of each respective channel extends in a curved manner between the respective end points in which the channels 106, 108 interrupt a cylindrical sidewall of the first part 102 of puck 22. Although not shown in FIG. 2B, second portion 104 of puck 22 may optionally include a complementary upwardly extending first extension and an upwardly extending second extension that are shaped complementary to channels 106, 108, respectively. In one particular embodiment, a portion of extension is configured to nest or fit within channel 106 and a portion of extension is configured to fit within or nest within channel 108. The uppermost surface of each respective extension may be a concave surface configured to have a similar radius of curvature as cable 24 such that when the first part 102 is secured to the second part 104 via a central screw 116, the extensions 112, 114 fit and secure a cable through the respective channels 106, 108 within puck 22.

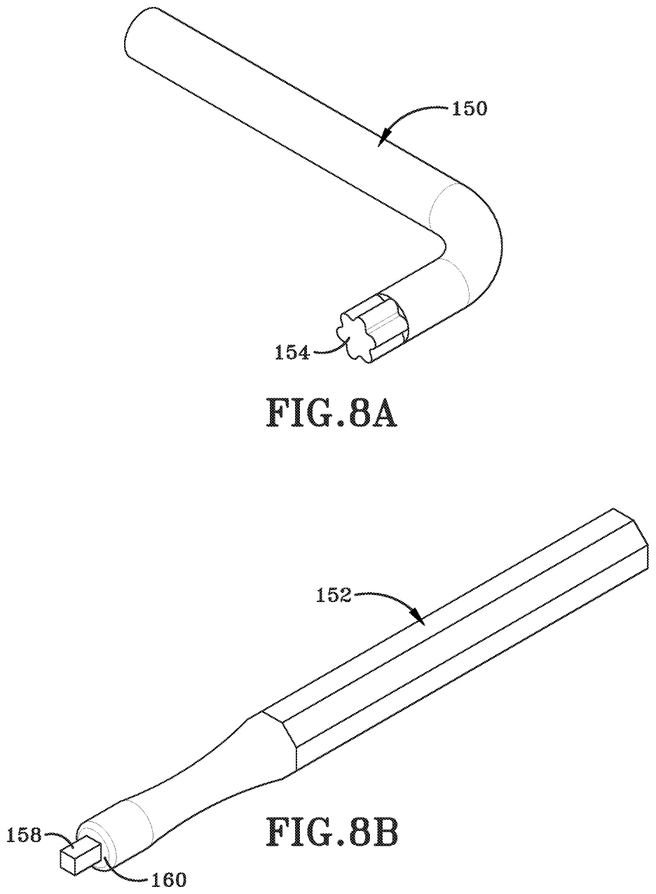

First portion 102 of puck 22 is a general unibody member configured to snap or otherwise be releasably secured with second portion 104 of puck 22. The first portion 102 and the second portion 104 of puck 22 are configured to join or form a union and be aligned along the puck axis 110. Puck axis 110 does not intersect the cables 24 when they are strung through the channels 106, 108 in the first portion 102 of puck 22. Additionally, puck 22 does not provide an adjusting feature for the length of the cables 24, rather, the channels 106, 108 simply act as channels to house portions of the cable 24 therein, such that the length of the cable 24 is to be adjusted by rotating gear 14 using a mechanism, which is generally introduced in FIG. 8A, to rotate the gear and the central hub 16 about the first axis 38 to shorten the length of the cable 24 relative to the retail item in order to secure the security device 10 to a retail item. In one particular embodiment, there is a first cable having first and second ends defined by barrels 58 coupled to the gear 14. A second cable has first and second ends coupled to the gear 14. The puck 22 is connected to the first cable and the second cable intermediate the respective first and second ends of the first cable and the second cable.

Referring back to FIG. 2A and FIG. 3, the gear 14 is placed centrally within housing 12 such that the bore of cylinder 60 is aligned along the first axis 38. When viewed from above with cover 34 removed, retention member 54 defines the slots 56 as generally curvilinear such that the barrels 58 are retained by the retention member 54 orthogonal relative to each other and parallel to an opposing barrel 58 located on an opposite side of first axis 38. Each slot 56 formed in the retention member 54 may define a curvilinear profile eccentric to the first axis 38. The pathway of each respective slot 56 enables cable 24 to extend in a manner in which the cable transitions approximately 90° from the location of the barrel 58 to an exterior surface of the retention member 54. The curving profile of the slots 56 is to encourage unidirectional rotation of the gear 14. The unidirectional rotation of the gear 14 about the first axis 38 decreases the length of the cable 24 as it is wrapped around a box or other device through which device 10 is configured to secure or monitor.

As depicted in FIG. 3, the center hub 16 is disposed above disc 48 and retention member 54 of gear 14. Center hub 16 includes a cylindrical outer profile defined a cylindrical sidewall 62 with a downwardly extending extension member 64 (FIG. 1) that fits within complementary openings 59 formed in retention member 54 of gear 14. Central hub 16 defines an inner cylinder 66 defining an interior bore 67 that is sized complementary to an outer diameter of cylinder 60 on gear 14. The cylinder 66 on central hub 16 is longitudinally aligned with first axis 38 such that cylinder 66 receives cylinder 60 therein. When the outer surface of cylinder 60 on gear 14 is received within central hub 16, the outer surface of cylinder 60 is closely adjacent the interior surface defining the central bore 67 of cylinder 66.

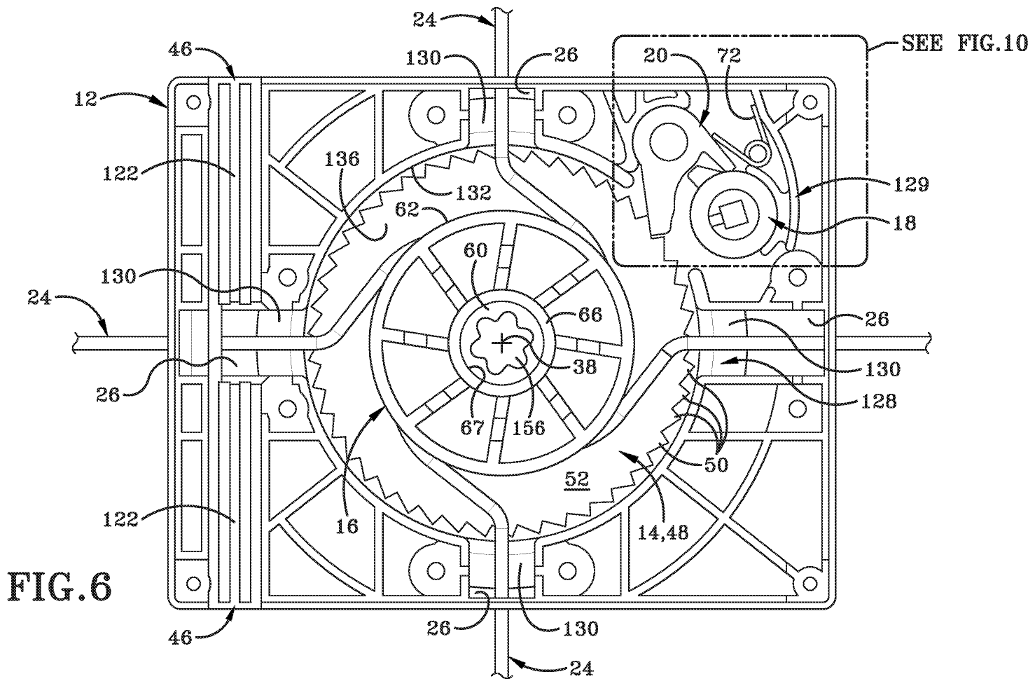

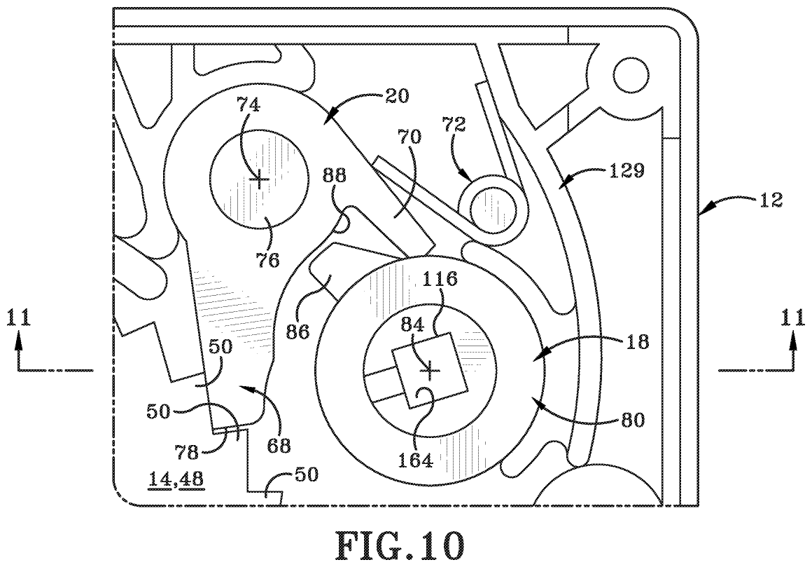

With continued reference to FIG. 2A, FIG. 6, and FIG. 10, the pawl 20 is disposed within the interior of housing 12 eccentric to the first axis 38. The pawl 20 includes a first arm 68 and a second arm 70. First arm 68 is positioned to interact with teeth 50 on gear 14. Second arm 70 interacts with a torsion spring 72 to bias the first arm 68 about a pawl axis 74, such that the first arm 68 ratchetly interacts with the teeth 50 of gear 14 to define a ratchet action or ratchet connection. Pawl axis 74 is offset parallel to first axis 38. Pawl 20 may further include an upwardly extending solid cylinder 76 that is aligned centrally to the pawl axis 74. Cylinder 76 may be sized so as to extend upwardly and interconnect and be retained by the downwardly extending major surface of the cover 34 on housing 12 or another portion of housing 12. In one particular embodiment, the vertical length of the cylinder 70 is approximately one and a half times that of the height of each of the arms 68, 70. First arm 68 may include a flat terminal end 78 configured to engage teeth 50 on disc 48. First arm 68 may also have a concavely curved portion has a radius of curvature complementary to an outer radius of unlocking key 18. Second arm 70 may include a flat side surface configured to interact with a portion of the torsion spring 72 and another side surface configured to engage with the exterior surface of unlocking key 18 within the interior of housing 12, as discussed in greater detail herein. Torsion spring 72 is retained on its other side by a curved wall 129 of the housing 12. Accordingly, pawl 20 is positioned closely adjacent unlocking key 18 and a portion of the unlocking key 18 is disposed in the region defined by the pawl 20 between the first arm 68 and the second arm 70.

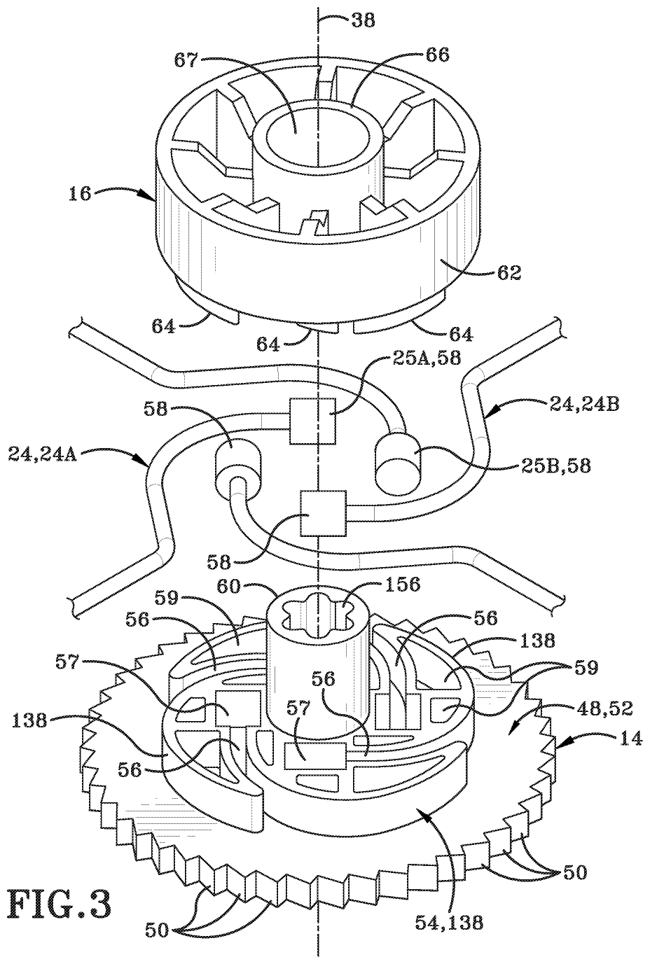

FIG. 2A and FIG. 4 depict that the unlocking key 18 is a generally cylindrical configuration having a cylindrical sidewall with an upper portion 80 and a lower portion 82. The upper portion 80 has a larger external diameter than the lower portion 88 measured through a central unlocking axis or lock axis 84. The upper portion 80 and the lower portion 82 are both coaxial along the axis 84. Lower portion 88 includes an arm 86 that protrudes radially outward from the lower portion 82 beyond the outer surface of upper portion 80. Arm 86 is configured to engage with a wall 88 on the pawl 20 when the unlocking key 18 is rotated about the lock access 84 as will be described in greater detail herein. Arm 86 is positioned in the space between first arm 68 and second arm 70 of pawl 20. Rotational movement of unlocking key 18 causes arm 86 to engage wall 88 and contact second arm 70 on pawl 20 to bias the pawl against the torsion spring 72 to disengage the first arm 68 from teeth 50 on disc 48 of gear 14. The inner surface 90 of the lower cylinder 82 is hollow and defines bore 166 and is configured to receive a compression coil spring 92 therein. Compression coil spring 92 engages a rectangular member 94 that sits within a complementarily shaped channel or recess of housing 12 to retain spring 92 within the interior bore of lower cylinder 82. Spring 92 engages defined by an upper wall 99 within the interior of the bore of unlocking key 18. Spring 92 biases the unlocking key 18 into the locked position such that downward force to compress spring 92 along the lock axis 84 may compress spring 92 to unlock the device 10 by disengaging the arm 86 and rotating the unlocking key 18 about lock axis 84. There may be an additional bar 93 that is positioned between the rectangular member 94 and the spring 92. In some instance, bar 93 may have magnetic properties or be formed of a metal that includes ferrous material (e.g., ferrite) to be attracted to a magnet on the unlocking tool 152 (FIG. 8B). Alternatively, the ferrous material could be on the end of the unlocking tool.

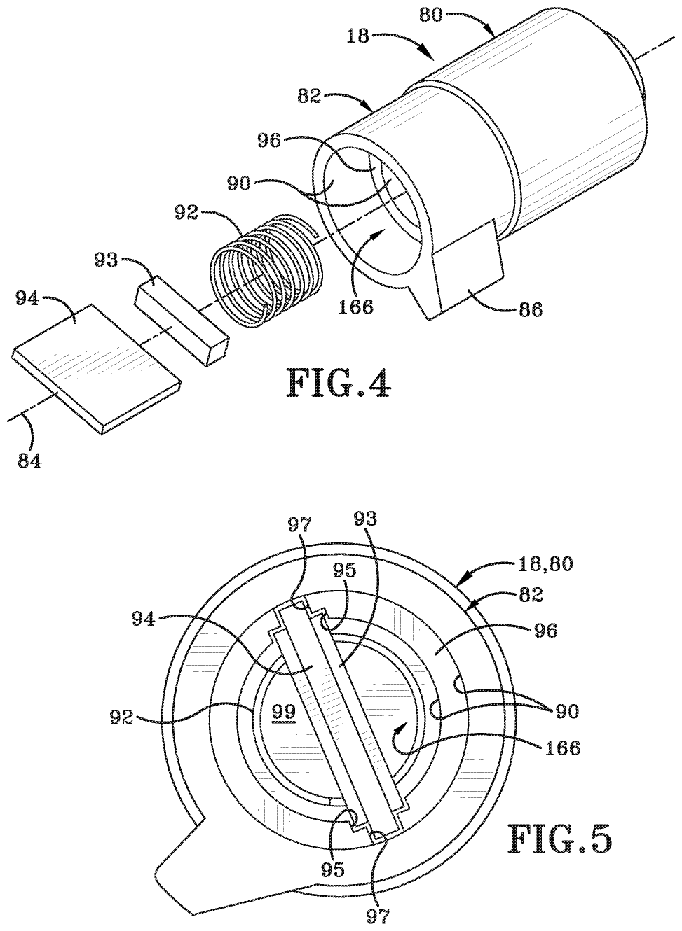

FIG. 5 depicts the assembled unlocking key 18 showing a wider first channel 95 and a narrower second channel 97 formed in the inner surface 90 of the unlocking key 18. The bar 93 is wider than the rectangular member 94 and reside within the wider first channel 95. The rectangular member 94 is narrower than the bar 93 and resides within the narrower second channel.

With continued reference to FIG. 2A and FIG. 3, a first cable 24A has a first end defined by barrel 58 and a second end defined by another barrel 58. A second cable 24B includes a first end defined by a barrel 58 and a second end defined by another barrel 58. The first end 25A of the first cable 24A includes barrel 58 that is to be disposed at a first position within a retention area 57 of the retention member 54. The second end 25B of the first cable 24A is defined by barrel 58 and retained within a retention area in the retention member 54 of gear 14. First end 25A is oriented 90° offset relative to the second end 25B, relative to the first axis 38. Stated otherwise, when viewed from above, the first end 25A is oriented to align the first end 90° or orthogonal to the alignment of the second end 25B. A similar arrangement is provided for the second cable 24B.

Referring back to FIG. 1, gear 14 is within housing 12 and the cover 34 in the closed position. When the cover 34 is in the closed position, cylinder 60 extends through the aperture 36 in the cover 34. The unique shape of the central bore 156 of cylinder 60 is exposed and viewable by looking at the cover 34. The keyway 40 and its opening defined thereby, expose the upper end of the unlocking key 18, which defines an inner bore that is continuous with the central bore defined by the inner wall 90 of the lower portion 82 of the unlocking key 18. The upper aperture of the bore may include a square-shaped edge 116 configured to receive an unlocking tool that is used to rotate, at least a portion of, the unlocking key 18 about the lock axis 84 to move the unlocking key between a locked position and an unlocked position as indicated by a lock icon 118 and an unlock icon 120.

FIG. 8A and FIG. 8B depicts a crank 150 and an unlocking tool 152. Crank 150 is shaped similar to an Allen wrench but has a distal end 154 that is shaped complementary to the central bore 156 of gear 14. As indicated elsewhere herein, the actual shape and configuration of the terminal end 154 and the complementary shaped bore 156 may be any configuration to provide a sufficient amount of torque and resistance to enable the crank 150 to rotate the gear 14 about the first axis 38 in order to shorten the length of the cables 24 to secure the puck 22 to a retail packaging. While a 6-pointed star configuration is shown throughout the figures any shape in possible, however, it may not be well-suited to provide a circular configuration as this may cause the crank 150 to simply spin within the central bore 156. As such, a 6-pointed star configuration, a 5-pointed star configuration, a triangular configuration, a square configuration, a hexagon configuration, a pentagon configuration, or any other configuration having flat or a plurality of curved surfaces could function as the terminal end 154 of crank 150.

The unlocking tool 152 is a generally elongated member having a terminal end 158 that is shaped complementary to the square recess 164 of the unlocking key 18. In this particular embodiment, the edge 116 is generally square-shaped and the terminal end 158 defines a square-shaped pin at the terminal end of the unlocking tool 152. The square-shaped pin extends outwardly from the tool and defines a shoulder 160. The unlocking tool 152 is configured to be inserted into the bore of the unlocking key 18 through edge 116. More particularly, the terminal end 158 is configured to be inserted into the bore through the keyway aperture 40 in the cover 34. The shoulder 160 may nest against the top surface of the unlocking key 18. Then the unlocking tool 152 may be pressed downwardly along the key access, which is offset parallel to the first axis 38. More particularly, as the tool 152 is pressed or moved along the key axis 84, the terminal end 158 may rotate the unlocking key 18 around the lock axis 84 to move the arm 86 into and out of engagement with pawl 20, such that the terminal end wall 78 of pawl 20 disengages teeth 50 to enable the gear 14 to wind or unwind.

With continued reference to FIG. 8B, while the unlocking tool 152 has been shown as a mechanical or locking release via its square-shaped distal end or pin 158, it is to be understood that the unlocking tool 152 may be customized with various different styles of end tips so as to create unique interfaces with the security device 10. For example, the distal end 158 of any respective unlocking tool 152 could be incorporated with a magnet release mechanism that cooperates with a complementary magnet in unlocking key 18 within security device 10. This would enable different key systems for different retailers to ensure that the unlocking key from a first retailer could not be used at another security device 10 associated with a different retailer.

The terminal end 158 of unlocking tool 152 may include a quarter-inch square magnet on the end of the handle of the unlocking tool 152. When the square magnet at the terminal end 158 is inserted into the square hole or recess 164, a steel pin is released, which allows the unlocking part of the unlocking key 18 to rotate and release the locking pawl 20. This allows the spool to be unlocked. This is a different type of unlocking mechanism from conventional security devices that would unlock a buckle but not the spool.

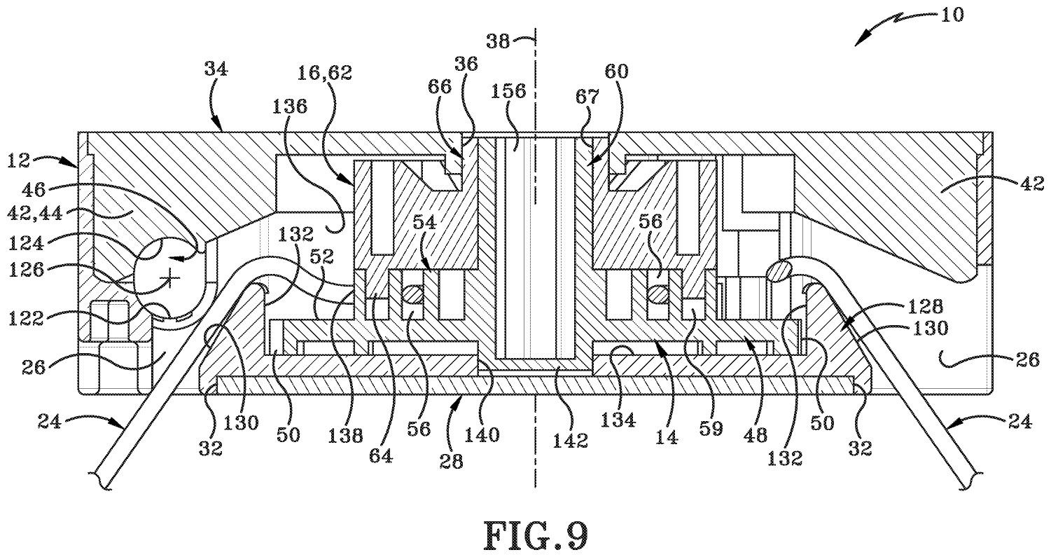

FIG. 9 depicts the security device 10 in cross-section taken along the length of housing 12 through the first axis 38. Pass-through channel 46 is defined by an upwardly extending concave surface 122 defined by an interior wall of housing 12 and a downwardly concave wall 124 on the downward element 44 of cover 34. The pass-through channel defines a transverse axis 126 that is configured to receive a secondary security cable or tether 200 (FIG. 14) therethrough. As described herein, pass-through channel 46 is configured to daisy chain a plurality of security devices 10 together or connect the security device 10 to a tether such that the retail item protected by security device 10 is rigidly tethered, anchored, or secured to a display table or other fixture within the retail environment.

Housing 12 further includes a retention member 128 having a tapered outer sidewall 130 and a vertical inner sidewall 132 defining a generally circular profile having a diameter that is slightly larger or complementary to the maximum outer diameter defined by teeth 50 on gear 14. Retention member 128 defines an upwardly facing top surface 134 that receives the lower portion, or lower major surface of disc 48 there above. A space 136 is defined between the vertical wall 132 on retention member 128 and the outer cylindrical wall 138 on the retention member 54 of gear 14. Space 136 defines a region in which the cables 24 may be wound and stored to reduce their length relative to a retail item in order to sync the puck 22 tightly or snugly against the retail packaging as the gear 14 is rotated about axis 38. Retention member 128 may further define a central recess 140 that receives a downwardly extending central portion 142 of the gear 14 to define a low friction interface between the sidewalls of the retention member 128 and the downwardly extending portion 142 to enable the gear 14 to rotate about the first axis 38 without significant movement in the transverse or lateral direction.

The outer cylindrical sidewall 62 of central hub 16 is of the same general outer diameter as outer wall 138 of gear 14. As such, outer cylindrical wall 62 partially defines the space 136 within the interior of housing 12 as the region where the cables 24 are wound and wrapped and stored within the housing 12 as a user rotates the gear and central hub about the first axis 38 to shorten the length of the cables in order to secure the puck to the retail device that is secured by security device 10.

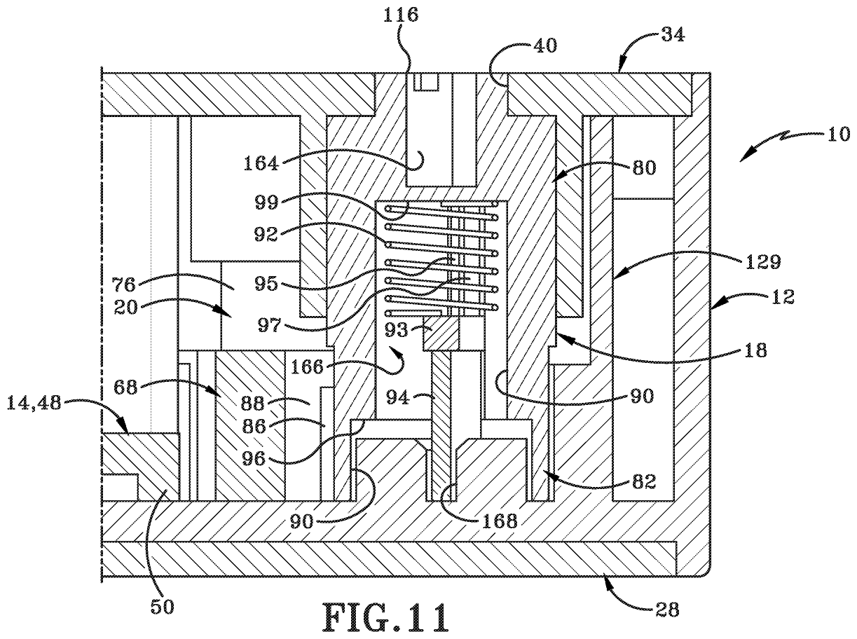

FIG. 11 depicts a cross-section of the unlocking key 18. The square upper edge 116 defines a complementarily shaped recess 164 that is coaxially aligned along the key axis 84 as the bore 166 defined by interior surface 90. Spring 92 sits against a seat defined by wall 99 to contact the bar 93 connected to rectangular member 94 that nests within a slot 168 of retention member 128. Alternatively, a steel pin can be a spring-loaded steel plate that is magnetically attracted to the magnetic key on unlocking tool 152 for lifting out of the corresponding transverse slot 168 in the member 128, allowing the latching mechanism (i.e., pawl 20 and unlocking key 18) of to be released.

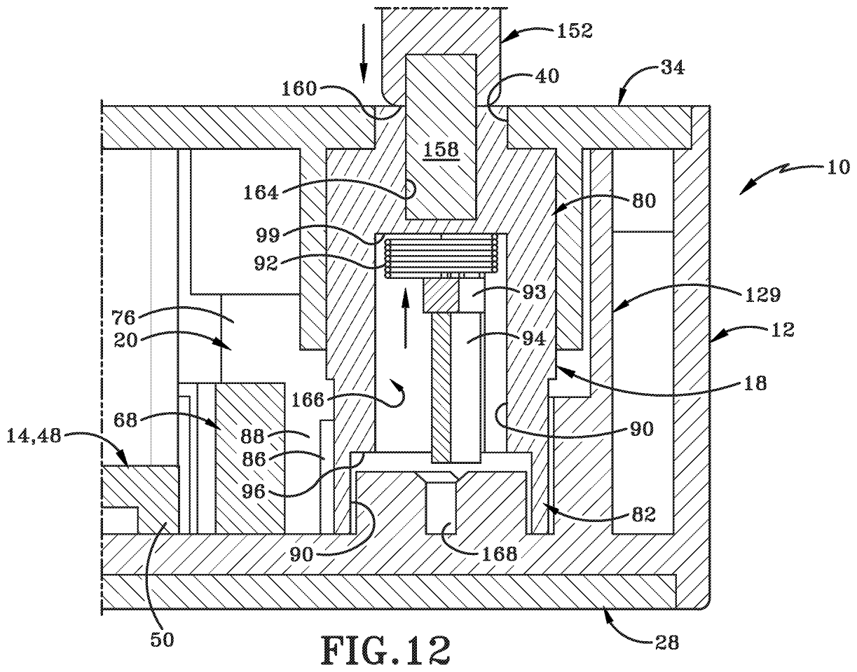

FIG. 12 depicts an operational cross section view of the unlocking key 18. The terminal end 158 of unlocking tool 152 is inserted into the square recess 164 of the unlocking key 18. The magnetic attraction between the terminal end 158 and either the bar 93 or the rectangular member 94 compresses spring 92. As spring 92 is compressed, the rectangular member 94 is lifted and released from slot 168. When the rectangular member 94 is disengaged from slot 168, the unlocking key 18 may be rotated about the lock axis 84 by rotating the unlocking tool 152.

Having thus described some exemplary structural configurations of the exemplary security device 10. Reference will now be made to its operation and its operational advantages with respect to a single device and how one device may interact with a plurality of other devices.

Security device 10 is configured to be connected with a retail product or retail packaging product in order to prevent or otherwise dissuade theft of the retail packaging device to which device 10 is connected. Security device 10 may include an alarming product, such as a tamper alarm, which is sometimes commercially known as a 2-alarm product. Alternatively, security device 10 may be an EAS-activated alarm, which is sometimes referred to as a 3-alarm product. The 3-alarm product protects expensive, valuable items such as designer coats, bags and luggage. This 3-alarm offers three levels of protection: 1. It triggers the alarms on the pedestals when it passes the exit; 2. The tag continues to self-alarm once it has passed the pedestals and is in motion; and 3. It also self-alarms once the wire (such as cable 24) is cut. The alarm components may be stored within the interior chamber or central space defined by housing 12 within various parts of recesses or spaces not occupied by the gear components or the unlocking components. Additionally, the alarm functionality or the alarm mechanisms, which may be controlled by alarm logic, may be contained within the puck 22. The alarm logic may be used to sense improper movements that would trigger an alarm, notifying a retail store owner of a potential occurring theft.

The security device 10 may further be integrated with a plurality of sensors that cooperate with the alarm logic to sense various changes that would represent an alarming event. The alarm logic, or alarm controls, may be embedded within housing 12 and can be associated with sensors that sense movement of the device 10 secured to a retail item. For example, different sensors sense different data signatures, which may be coded into the alarm logic and activate the same in response to an alarm event. Some exemplary sensors capable of being electronically coupled with the alarm logic (either integrally in housing 12 or puck 22 or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, flights of stairs, climbed, local pressure changes, submersion in liquid; impellers measuring the amount of fluid passing thereby; Response Sensors sensing exertion/arousal levels; Global Positioning sensors sensing location, elevation, distance traveled, velocity/speed; Electromyography sensors sensing electrical pulses; Audio Sensors sensing local environmental sound levels, voice detection; Photo/Light sensors sensing ambient light intensity, ambient Day/night, sleep, UV exposure; TV sensors sensing light wavelength watching, indoor v. (vs?) outdoor environment; Temperature sensors sensing internal temperature, ambient air temperature, and environmental temperature; Moisture Sensors sensing surrounding moisture levels; radiofrequency (RF) sensors sensing wavelength propagating through a medium; and inductive sensors sensing inductive energy or capacitance.

In order to attach the security device to a retail object, a user, which is typically a retail employee but could be an employee of the product supplier (or even a robotic machine), will insert the unlocking tool 152 into the unlocking key 18 via its recess 164, which is exposed through the keyway aperture 40 in the cover 34 of housing 12. The user will maneuver the unlocking tool 152 via guidance by the icons 118, 120, to move the unlocking key 18 from the locked position to the unlocked position. Movement of the unlocking key from the locked position to the unlocked position may be accomplished, according to one embodiment, via rotational movement. More particularly, the unlocking key 18 rotates about the lock axis 84 between the unlocked position and the locked position, or vice versa.

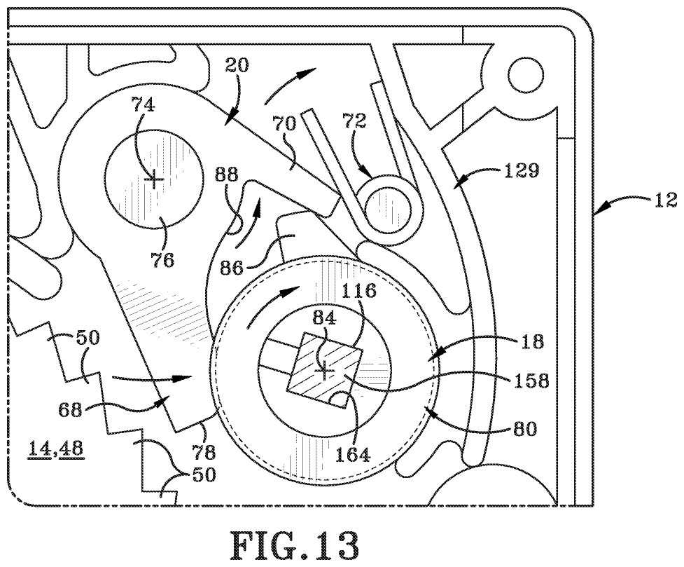

FIG. 13 depicts that as the unlocking tool 152 drives the rotation of the unlocking key 18 about the lock axis 84, the arm 86, carried by the lower portion 82 or the unlocking key, moves about the lock axis 84. In other embodiments, a magnet may be used to unlock the unlocking key 18. When the unlocking key 18 is in the unlocked position, the first arm 86 engages the pawl 20 to move it about the pawl axis 74. More particularly, the arm 86 on the unlocking key contacts the second arm 70 to rotate the pawl 20 about the pawl axis in a direction opposite the direction of rotation of the unlocking key. In one particular embodiment, in order to unlock the unlocking key 18, the unlocking key 18 would be rotated in the clockwise direction about the lock axis 84. The clockwise rotation of the unlocking key would engage the second arm 70 of pawl 20 to rotate the pawl slightly in the counterclockwise direction against the biasing force of the torsion spring 72. The counterclockwise rotation of the pawl 20 about pawl axis 74 would disengage the terminal end 78 of the second arm 68 from the teeth 50 on gear 14. With the pawl 20 unlocked from the teeth, the gear 14 would be able to freely spin about the first axis 38. The cables 24 would be able to be unspooled or unwound in order to increase their length such that the retail packaging product could be positioned between the lower surface of the bottom cover 28 of housing 12 and the puck 22. The unlocking tool 152 may be moved back towards the locked position and the torsion spring 72 would bias the second arm 70 in the opposite direction, such as the clockwise direction, in order to engage the first arm 68 at its terminal end 78 with one of the teeth 50 on gear 14.

With the cables 24 in their unspooled or unwound position, the user may use the crank 150 and insert its distal end 154 into the central bore of the gear 14 defined by cylinder 60. As indicated herein, the bore of cylinder 60 is shaped complementary to the distal end of the crank 150. The distal end 154 of the crank 150 may be a 6-pointed star or any other configuration that would encourage rotational movement without slippage about the first axis 38 as crank 150 is manually manipulated. In one particular embodiment, the crank is rotated in the clockwise direction in order to shorten the cables relative to the retail item by winding the cables around the retention member 54 on gear 14. More particularly, the distal end 154 is inserted into the bore of cylinder 60 of gear 14 and the crank 150 is rotated about the first axis 38 in the clockwise direction and during the clockwise rotation of gear 14, the teeth 50 engage pawl 20 at its terminal end 78 of the first arm 68 to define a one-way ratcheting configuration. The continued cranking of gear 14 in the clockwise direction causes the cables 24 to wind around the cylindrical sidewall 138 of the retention member 54 and the cylindrical sidewall 62 of the central hub 16 within the free space 136. The user may continue cranking the cables to shorten their overall length relative to the retail item until the retail item is snugly secured between the lower cover 28 and the puck 22.

FIG. 14 depicts a plurality of security devices 10 tethered together. A first security device 10 is positioned at an end of a chain or series of security devices. A tether 200 connects the first security device 10A with a second security device 10B. Tether 200 further connects a third security device 10C with the second security device 10B. Tether 200 extends from a first end 202 to a second (not shown) inasmuch as the tether 200 is shown as cutoff by an arbitrary dot-dash cutline, however, it is to be understood that the terminal second end of tether 200 will couple to the end security device of the any-number chain or series of security devices. First end 202 may be secured to the first security device 10A via a tether lock 204. The tether lock 204 includes a lock member having a size or dimension that is greater than the pass-through channel 46 defined by each respective housing 12 of the first security device 10A, the second security device 10B, and the third security device 10C. In one particular embodiment, tether 200 is an elongated cable extending through the pass-through channel or passageway 46 on each respective housing 12 such that the security devices 10A-10C may be connected together to form a plurality of coupled security devices that would each individually hold a retail product. A chain of connect retail products could be tethered at the second terminal end of tether 200 to an anchor on a retail display.

In operation, and with reference to FIG. 14, the tether 200 may be inserted through the pass-through channel 46 without ever removing the cover 34. Inasmuch as the pass-through channel 46 extends fully between sides of the housing 12, the open apertures defined as the respective ends of the pass-through channel 46 may simply enable to tether 200 to be threaded through the pass-through channel without requiring removal of the cover 34. Alternatively, an operator may remove the cover 34 of housing 12 to expose the pass-through channel 46. The tether 200 may be disposed within the past-through channel 46. cover 34 may be reinstalled to fully enclose the tether 200 within the pass-through channel 46.

In one particular embodiment, the longitudinal axis of the tether 200 may be co-aligned or positioned coaxial with the transverse axis 126. The tether may contact the concave surface 122 defined by the pass-through channel 46. The first security device 10A can then be considered to be tethered to the tether 200. When the first security device 10A is near the end of the tether 200, the tether lock 204 may be moved to its locked position to ensure that the first security device 10A, which will be secured to the retail item or retail packaging, does not slide or can be removed from the end of the tether. After the first security device 10A is secured to the tether 200, the second security device 10B may be secured to the tether 200. In a similar manner, the second security device 10B may be disposed in its pass-through channel by either inserting it, in a threading-like motion, the tether through the pass-through channel 46 of the security device 10B. However, it is possible that the cover 34 of the housing 12 of the second device 10B could be removed to dispose the tether 200 in the pass-through channel 46. This process may be continued in a serial manner to attach any number of security devices to the tether 200. Alternatively, the first security device 10A may simply be tethered to an anchor, which is usually rigidly and permanently secured in the retail environment.

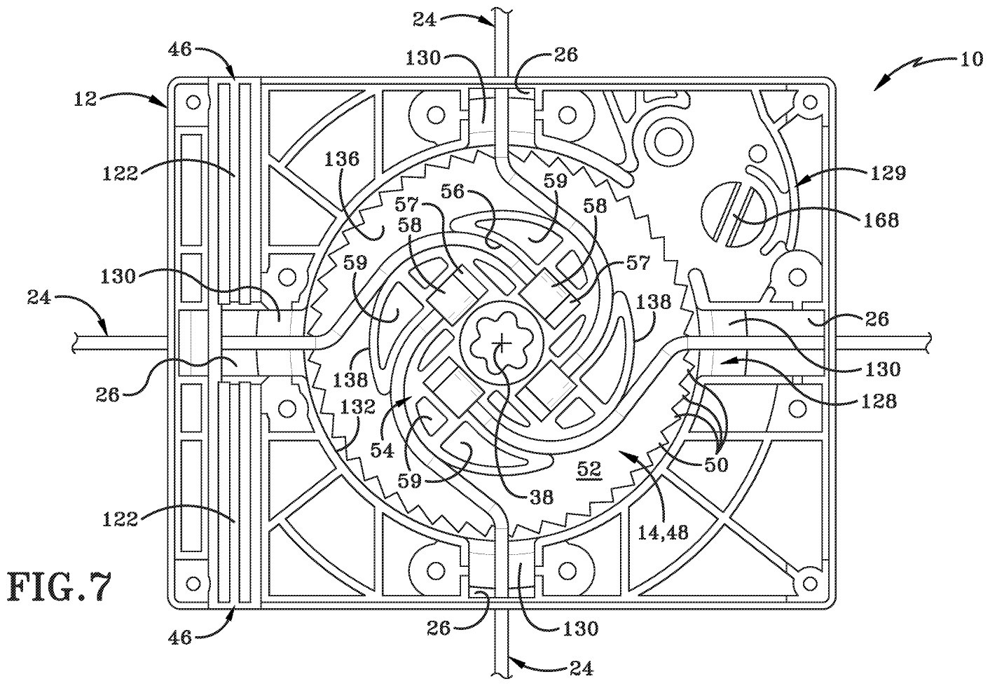

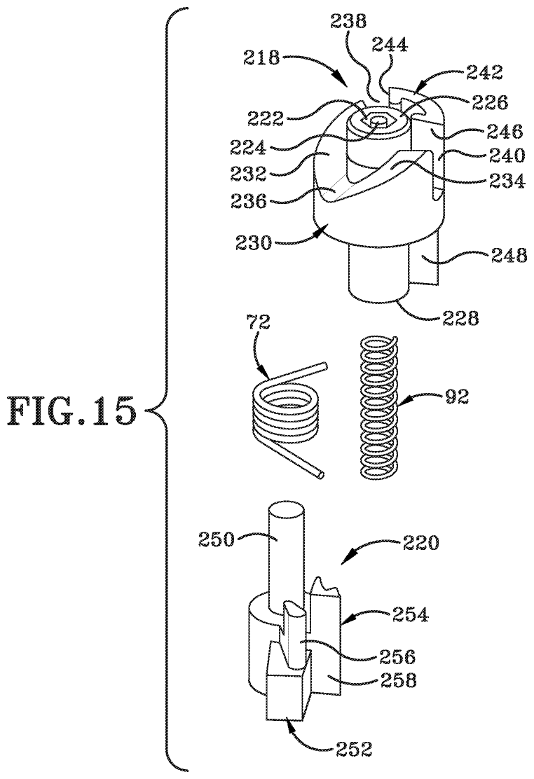

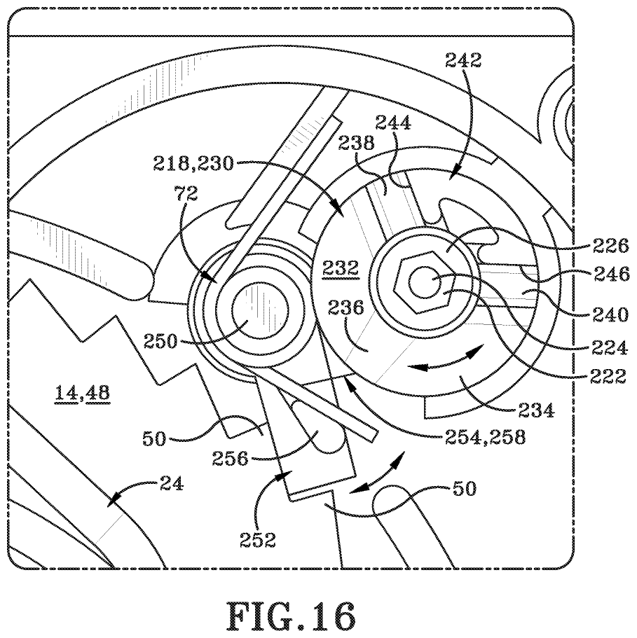

FIG. 15 and FIG. 16 depict alternative embodiments of components of the security device in accordance with the present disclosure. More particularly, the embodiments depicted in FIG. 15 and FIG. 16 depict slight variations to the unlocking key and the pawl of security device 10, which would accomplish similar objectives of security device 10 depicted in FIG. 1-FIG. 13. Although, the unlocking key depicted in FIG. 15 and FIG. 16 indicates that the arm, while being shaped differently than the unlocking key depicted in FIG. 1-FIG. 13, still interacts with the space between first and second arms on the pawl. Notably, the first and second arms on the pawl are shaped differently than those identified in FIG. 1-FIG. 13, however, the interaction of the unlocking key with the pawl is similar by the unlocking arm on the unlocking key engaging the second arm to disengage the terminal end of the first arm on the pawl on the teeth from the gear. The unlocking key depicted in FIG. 15 and FIG. 16 rotates about its respective lock axis to engage the pawl to move the pawl from an engaged and locked position to a disengaged and unlocked position.

Unlocking key 218 includes a top recess 222 that may have any shape that is complimentary to the terminal end of an unlocking tool. In one particular embodiment, top recess 222 has a hexagonal configuration with a central pin 224 therein. Unlocking key 218 includes a cylindrical body extending from an upper end defined by a top wall 226 and a lower end 228. Unlocking key 218 includes a collar 230 between the top wall 226 and the lower end 228 of the unlocking key 218. Collar 230 has a unique configuration with two curved flared sections. More particularly, a first flared wall 232 and a second flared wall 234. The flared walls 232, 234 extend upwardly and helically around the cylindrical body of the unlocking key extending upward and around the cylindrical body from a valley 236. The first flared wall 232 terminates at a vertical wall that defines a portion of a first slot 238. The second flared wall 234 terminates at a vertical wall that defines a portion of a second slot. Unlocking key 218 includes a semi arcuate member 242 that arcuately extends between a first end wall 244 and a second end wall 246. Similar to the previous unlocking key, the cylindrical body of unlocking key 218 may be hollow that defines a bore that is to receive compression coil spring 92 therein. Unlocking key 218 may further include a lower member 248 that extends below the collar 230 that is able to engage a portion of the pawl 220.

Pawl 220 includes an upper cylindrical extension 250 that extends through the central aperture defined by torsion spring 72. Pawl 220 includes, near its lower end, a first arm 252 and a second arm 254. The first arm 252 is generally square-shaped in cross section and has a second extension 256 extending upwardly therefrom. As shown in FIG. 16, the extension 256 acts as a seat for one of the spring arms of torsion spring 72. Thus, when the first arm 252 is moved into and out of engagement of the teeth on the gear, as best seen in FIG. 16, the torsion spring 72 biases the first arm towards the teeth. The second arm 254 includes a first surface 258 that is configured to engage the lower member 248 of the unlocking key 218. In operation and as shown in FIG. 16, when the pawl 220 is in the locked positon the first arm 252 engages the teeth. The pawl is biased towards the teeth based on the placement of the torsion spring 272 being urged to its resting position based on the placement of one of the spring arms adjacent the upper extension 256. To unlock the pawl 220, the unlocking tool is inserted into the recess 222 on the unlocking key 218. The unlocking key 218 is rotated about its lock axis. In this particular embodiment, direction to unlock the unlocking key 218 is accomplished by rotating the unlocking key in the clockwise direction. In this clockwise rotation of the unlocking key 218, the lower member 248 rotates to contact the surface 258 on the second arm 254 of pawl 220. The force of the rotation of the unlocking key overcomes the biasing force of the torsion spring 72 to rotate the pawl about its pawl axis. The pawl is then disengaged from the gear to allow the gear to freely rotate and spin. When the unlocking key is removed, the torsion spring 72 biases the pawl back into engagement with the teeth on the gear.

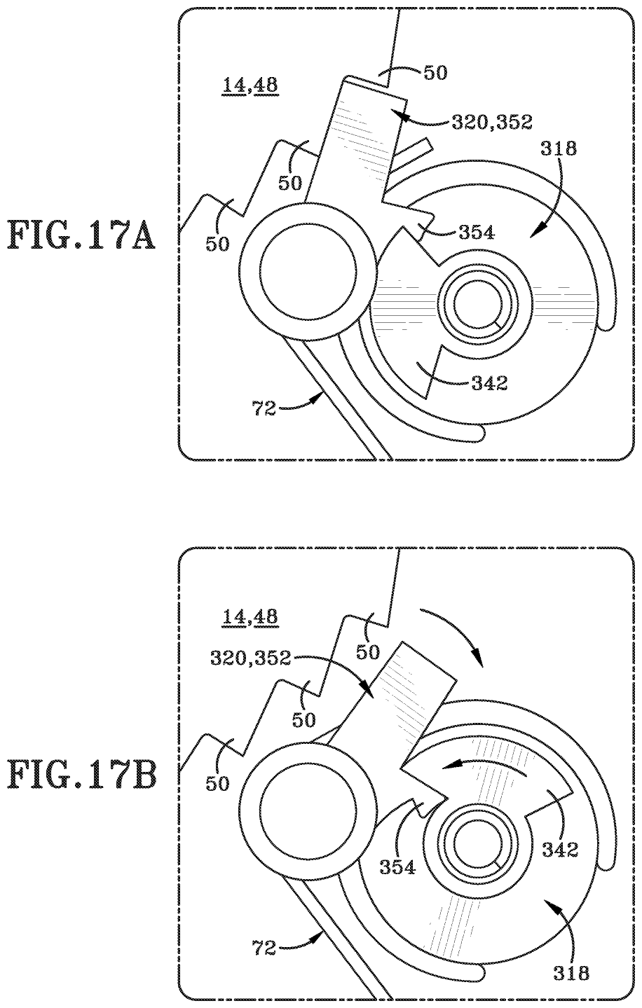

FIG. 17A and FIG. 17B depict alternative embodiments of an unlocking key and pawl. Namely, an unlocking key 318 and a cooperative pawl 320 are shown in which counterclockwise rotation of the unlocking key 318 is utilized to effectuate an unlocking movement of the pawl 320. In this particular embodiment, the unlocking key 318 includes an arcuate member 342 that rotates with rotational movement of the unlocking 318 to engage a second arm 354 on the pawl 320. When the arcuate member 342 engages the second arm 354, a first arm 352 on the pawl 320 is disengaged from the teeth on the gear. When the first arm 352 is disengaged from the teeth on the gear, the gear may freely rotate about the central axis of the security device to wind the cables.

In another alternative embodiment, any embodiment of the unlocking key and pawl (18,20 or 218,220 or 318,320) could have three positions instead of the aforementioned two positions (i.e., unlocked position and locked position). In this alternative embodiment having three positions, the key and pawl are arranged to operably interact beginning with an unlocked first position. In the unlocked first position, the cables 24 may be tightened or loosened as needed to fit around the retail item. Then, the unlocking tool may move the unlocking key within the housing to the locked second position. In the locked second position, the cable 24 can be tightened by not loosened. Further, the unlocking tool may move the unlocking key within the housing to a locked third position. In the locked third position, the cable is fixed relative to gear 14 and cannot be tightened and cannot be loosened; stated otherwise, the cable remains at a fixed positioned. Whether the unlocking key and pawl are in the locked second position or the locked third position will be based on how the pawl interacts with the teeth 52 of gear 14. For example, in the locked third position, the unlocking key interacts with the pawl while the pawl engages the teeth 52 to preclude the ratcheting action of the gear 14. One exemplary advantage of having a locked third position is an increased anti-theft feature that makes it more difficult for a thief to use a homemade tool to force the cables open.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of alarm technology incorporated into device 10 disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the alarm software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various alarm methods or processes outlined herein may be coded as alarm software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more alarm programs that, when executed on one or more computers or other processors, perform methods that implement the various alarm embodiments of the disclosure discussed above. The computer readable medium or media can be transportable, such that the program or programs stored thereon can be loaded onto one or more different computers or other processors to implement various aspects of the present disclosure as discussed above.

The terms alarm “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic” or “alarm logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “top”, “bottom”, “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees, inverted 180 degrees, or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A security device comprising:
a housing;
a cable extending through the housing and adapted to extend around a package or item;
a first axis of the housing;
a gear for winding the cable, wherein the gear is within the housing and rotatable about the first axis; and
an unlocking key or mechanism operably connected to the gear within the housing, wherein the unlocking key or mechanism is moveable between a first unlocked position and a second locked position, wherein when in the unlocked first position the elongated cable freely unwinds and when in the locked second position the elongated cable cannot unwind relative to the gear.

2. The security device of claim 1, further comprising:
a third locked position of the unlocking key or mechanism, wherein when in the locked third position the elongated cable is fixed and cannot wind and cannot unwind relative to the gear.

3. The security device of claim 1, further comprising:
a lock axis offset from the first axis;
a first portion of a sidewall on the unlocking key or mechanism oriented around the lock axis; and
an arm extending radially outwardly from the first sidewall relative to the lock axis.

4. The security device of claim 3, further comprising:
a second portion of the sidewall on the unlocking key or mechanism, wherein the first and second portion of the sidewall extend coaxially along the lock axis.

5. The security device of claim 4, further comprising an external diameter on the first portion of the sidewall and the on the second portion of the sidewall, wherein the external diameter is different for each of the first and second portions of the sidewalls.

6. The security device of claim 5, further comprising:
wherein the arm is connected to the second portion of the sidewall below the first portion of the sidewall.

7. The security device of claim 1, further comprising:
a lock axis;
a bore defined by the unlocking key or mechanism;
a magnetically attractable member disposed within the bore, wherein the bar is configured to move along the lock axis relative to the bore.

8. The security device of claim 7, further comprising:
a spring disposed within the bore.

9. The security device of claim 1, further comprising:
a lock axis that is offset from the first axis of the housing;
a pawl defining a pawl axis offset parallel to the lock axis and to the first axis of the housing;
the pawl including first and second arms that define a space therebetween;
an arm on the unlocking key or mechanism disposed in the space between the first arm and the second arm of the pawl.

10. The security device of claim 9, further comprising:
a torsion spring connected to the second arm of the pawl.

11. The security device of claim 1, further comprising:
a pass through channel defined in the housing adapted to receive a tether therethrough that couples the security device to an anchor or another similar security device via the tether.

12. The security device of claim 1, further comprising:
a spring coupled to the unlocking key or mechanism providing a force along a lock axis that is parallel to the first axis of the housing, wherein the gear rotates about the first axis of the housing; and
an unlocking tool adapted for use with the unlocking key to move the unlocking key between the unlocked and locked positions, wherein the unlocking tool has a portion complementary to the unlocking key.

13. The security device of claim 1, further comprising:
a first cable having first and second ends coupled to the gear;
a second cable having first and second ends coupled to the gear;
a puck connected to the first cable and the second cable intermediate the respective first and second ends of the first cable and the second cable.

14. The security device of claim 13, further comprising:
a first portion of the puck defining a first channel receiving the first cable and a second channel defining the second cable;
a second portion of the puck that couples to the first portion to retain the first and second cables in the first and second channels, respectively.

15. The security device of claim 1, further comprising:
a central bore defined by a cylinder for rotating the gear, wherein the central bore is accessible through the housing.

16. A method comprising:
inserting an unlocking tool into a unlocking key that is exposed through a keyway aperture formed in a housing of a security device;
moving the unlocking tool to move the unlocking key from a locked position to an unlocked position;
engaging a first arm on a pawl with a portion of the unlocking key;
disengaging a second arm on the pawl from a gear within the housing;
unwinding cables that are spooled relative to the gear while rotating the gear; and
increasing a length of the cables relative to an outside of the housing configured to enable a retail item to be removed from the security device.

17. The method of claim 16, further comprising:
rotating the pawl about a pawl axis in response to moving the unlocking tool to move the unlocking key from the locked position.

18. The method of claim 17, further comprising:
biasing the pawl from the unlocked positon towards the locked position with a torsion spring operably coupled to pawl and the housing;
wherein there are two locked positions, one locked position in which the cables may be tightened but not loosened and another locked position in which the cables are fixed and may neither be tightened nor loosened.

19. The method of claim 17, wherein moving the unlocking tool is accomplished by rotating the unlocking tool about a lock axis that is offset parallel to the pawl axis and further comprising:
magnetically attracting a portion of the unlocking tool to a portion of the unlocking key.

20. The method of claim 16, wherein the security device is a first security device from a plurality of similar security device, further comprising:
connecting the first security device to a first object protected by the first security device;
positioning a tether in a pass-through channel defined by a portion of a first security device;
connecting the tether to one of: (i) an anchor; and (ii) a second security device via a pass-through channel defined by a portion of the second security device protecting a second object; and
displaying the first object in a retail environment.
